(19) United States
(12) Patent Application Publication
(10) Pub. No.: US 2015/0335210 A1
(43) Pub. Date: Nov. 26, 2015

(54) STACK OF INTERFOLDED ABSORBENT SHEET PRODUCTS, USE OF THE SAME IN A DISPENSER, METHOD FOR MANUFACTURING THE SAME

(71) Applicant: SCA TISSUE FRANCE, Saint -Ouen (FR)

(72) Inventors: Yoann DENIS, Selestat (FR); Matti ELLONEN, Colmar (FR); Donald BARREDO, Ingersheim (FR); Loic SIEBER, Rixheim (FR)

(73) Assignee: SCA TISSUE FRANCE, Saint-Ouen (FR)

(21) Appl. No.: 14/654,879

(22) PCT Filed: Dec. 24, 2012
(86) PCT No.: PCT/EP2012/076869

§ 371 Date: Jun. 23, 2015

(51) Int. Cl. A47K 10/16; B65H 45/24; A47K 10/42; B65G 57/00

(52) U.S. Cl. CPC A47K 10/16; B65G 57/00; B65H 45/24; A47K 10/426; A47K 10/427

(57) ABSTRACT

A stack of interfolded absorbent sheet products includes a plurality of a first group of absorbent sheet products folded according to a first type of folding wherein at least two panels are created by one folding line, and a plurality of a second group of absorbent sheet products folded according to a second type of folding wherein at least two other panels are created by at least one other folding line. The plurality of the first and second groups are orientated side by side in opposition relative to each other, the plurality of the first and second groups being interfolded into each other so that the panels of two groups positioned adjacent relative to each other overlap. Each group of absorbent sheet products includes a certain amount, at least two, of uncoupled absorbent sheet products so as to dispense the certain amount of absorbent sheet products with one grasping movement of the group.

### CROSS-REFERENCE TO PRIOR APPLICATION

This application is a §371 National Stage Application of PCT International Application No. PCT/EP2012/076869 filed Dec. 24, 2012, which is incorporated herein in its entirety.

### TECHNICAL FIELD

The disclosure relates to a stack of interfolded absorbent sheet products. The disclosure also relates to a use in a dispenser for dispensing such a stack of interfolded absorbent sheet products. Still another aspect of the disclosure relates to a method for manufacturing such a stack of interfolded absorbent sheet products. The absorbent sheet products may be manufactured from a web of tissue paper (obtained by a Conventional Wet Press or Through Air Drying manufacturing method or other manufacturing method) or a nonwoven fabric including cellulosic fibers (obtained by an air-laid manufacturing method or spun-laid manufacturing method or other manufacturing method). Such absorbent sheet products find a particular, though non exclusive, use as sanitary or domestic purposes. As an example, such absorbent sheet products may be used as napkins in quick service restaurant. Other uses as towels, bath tissues, etc . . . may be possible.

### BACKGROUND

A tissue paper relates to an absorbent paper based on cellulose fibers which is also called tissue paper base-sheet in this field of technology. A typical absorbent paper has a low basis weight, in the range from 10 to 50 g/m².

A nonwoven fabric including cellulosic fibers relates to an absorbent paper which is also called nonwoven or web made of fibers like air-laid web in this field of technology. A typical absorbent paper has a basis weight, in the range from 30 to 250 g/m², or, in particular embodiments, 40 to 80 g/m².

There exist various types of dispensers for dispensing absorbent sheet products to users. Often, such dispensers are provided in restaurants (e.g. fast food also known as quick service restaurants) or other public places. The users remove an amount of absorbent sheet products from the dispenser. The capacity of such dispenser may be adapted to the intended use. For example, in the context of a quick service restaurant, a large number of napkins may be dispensed in a short period of time to an important number of users. However, in such a context, this often results in difficulty to uniformly dispense a controlled number of napkins that is sufficient for the needs of the users, and/or a reasonable number of napkins that is not larger than necessary for the needs of the users. It is particularly difficult for a user to control the number of napkins dispensed in one grasping movement. In the context of, for example, fast food restaurants, as the dispensing must be done quickly, it is unthinkable to count the number of dispensed napkins in one grasping movement. There is a compromise between the overconsumption of napkins, and the gain or loss of time due to the dispensing.

Thus, there is a need to improve quality of dispensing, uniformity of dispensing and also to avoid wasting absorbent sheet products that are unnecessary to the users. Further, this should be obtained in economical or cost effective manner.

### SUMMARY

It is desired to propose a stack of interfolded absorbent sheet products that overcomes the drawbacks of the prior art absorbent sheet products. In particular, it is desirable to improve uniformity of dispensing of absorbent sheet products to a user.

According to one aspect, there is provided a stack of interfolded absorbent sheet products including a plurality of a first group of absorbent sheet products folded according to a first type of folding wherein at least two panels are created by at least one folding line, and a plurality of a second group of absorbent sheet products folded according to a second type of folding wherein at least two other panels are created by at least one other folding line, the plurality of the first and second groups being orientated side by side in opposition relative to each other, the plurality of the first and second groups being interfolded into each other so that the panels of two groups positioned adjacent relative to each other overlap, and wherein each group of absorbent sheet products includes a certain amount, at least two, of uncoupled absorbent sheet products so as to dispense the certain amount of absorbent sheet products with one grasping movement of the group.

The first type of folding may be either identical or different to the second type of folding.

The certain amount may range between two and six.

The sizes of the first group of absorbent sheet product relative to the second group of absorbent sheet product may be identical.

The type of folding may be chosen from among the group comprising V-fold wherein two panels are created by one fold, Z-fold wherein three panels are created by two folds made in opposite directions, and M-fold wherein four panels are created by three folds.

Characteristics of the first group of absorbent sheet products relative to the second group of absorbent sheet product may be different.

Characteristics of each uncoupled absorbent sheet products in a group may be different.

The absorbent sheet products may be chosen from among the group of absorbent sheet products comprising napkins, towels, kitchen towels, hand towels, toilet papers, wipes and facial tissues.

According to another aspect, there is provided a use of a stack of interfolded absorbent sheet products in a dispenser, the dispenser including a container wherein the stack of interfolded absorbent sheet products is disposed, and wherein the stack of interfolded absorbent sheet products is oriented in the dispenser so that when a user grasps one group of absorbent sheet products a certain amount of absorbent sheet products is seized at the same time.

A front face of the dispenser may include an opening allowing the group of absorbent sheet products to gape of the container and through which the stack of interfolded absorbent sheet products may be seized.

According to a further aspect, there is provided a method for manufacturing a stack of interfolded absorbent sheet products, the manufacturing method comprises:

folding a plurality of a first group of absorbent sheet products according to a first type of folding wherein at least two panels are created by at least one folding line;

folding a plurality of a second group of absorbent sheet products according to a second type of folding wherein at least two other panels are created by at least one other folding line;

orientating the plurality of the first and second groups side by side in opposition relative to each other, and interfolding the plurality of the first and second groups into each other so that the panels of two groups positioned adjacent relative to each other overlap;

wherein the method includes supplying each group of absorbent sheet products with a certain amount, at least two, of uncoupled absorbent sheet products.

The step of supplying the certain amount of uncoupled absorbent sheet products may include providing a tissue web formed out of several plies from a single supply roll, separating the tissue web formed out of several plies into the certain amount of uncoupled tissue webs, combining the certain amount of uncoupled tissue webs into combined tissue webs, and cutting the certain amount of uncoupled tissue webs of the combined tissue webs in a simultaneous manner.

The step of supplying the certain amount of uncoupled absorbent sheet products may further include structuring the tissue web formed out of several plies before the uncoupling step.

The step of supplying the certain amount of uncoupled absorbent sheet products may include providing uncoupled tissue webs from a certain amount of supply rolls, combining the certain amount of uncoupled tissue webs into combined tissue webs, and cutting the certain amount of uncoupled tissue webs of the combined tissue webs in a simultaneous manner.

The step of supplying the certain amount of uncoupled absorbent sheet products may further include structuring the tissue web formed out of several plies before the cutting step.

The step of supplying the certain amount of uncoupled absorbent sheet products may include providing multiple tissue webs from a certain amount of supply rolls, each roll providing a single tissue web, structuring the multiple tissue webs together, uncoupling the structured tissue webs into the certain amount of uncoupled tissue webs, combining the certain amount of uncoupled tissue webs into combined tissue webs, and cutting the certain amount of uncoupled tissue webs of the combined tissue webs in a simultaneous manner.

According to still a further aspect, there is provided a use of a stack of interfolded absorbent sheet products as napkins in a dispenser.

Because the certain amount of absorbent sheet products are processed together and simultaneously to form a group, the produced stack includes groups of napkins that are easy to handle. Thus, it is possible to dispense a certain amount of napkins with every grasping movement, for example, three napkins. This is of particular interest in the context of quick service restaurant applications. This is also well adapted to uniformly dispense a controlled amount of paper products from a large dispenser without dispensing more paper products than necessary to a user. This enables limiting the quantity of paper products that is removed by a user, and thus limiting waste of paper products.

Further, reducing the waste of consumption results in economical and environmental benefits, as similar or even better satisfaction of the users is obtained while using fewer paper products.

Other advantages will become apparent from the hereinafter description of embodiments of the invention.

### BRIEF DESCRIPTION OF THE DRAWINGS

Embodiments of the invention are illustrated by way of examples and not limited to the accompanying drawings, in which like references indicate similar elements:

FIGS. 1 and 3 schematically illustrate side cross-section views of exemplary embodiments of stacks of interfolded absorbent sheet products;

FIG. 2 schematically illustrates, in detail, an absorbent sheet product folded according to a V-fold type of folding;

FIGS. 4 and 5 schematically illustrate an exemplary embodiment of a dispenser for dispensing stacks of interfolded absorbent sheet products; and

FIGS. 6 to 9 schematically and partially illustrate four exemplary embodiments of a machine and method for manufacturing stacks of interfolded absorbent sheet products.

### DETAILED DESCRIPTION OF PARTICULAR EMBODIMENTS

In the following description of the drawings, only the V-fold type of folding, wherein two panels are created by one fold is depicted and described for a mere sake of clarity and conciseness. The various embodiments are easily adapted to other kind of folding, e.g. Z-fold and M-fold.

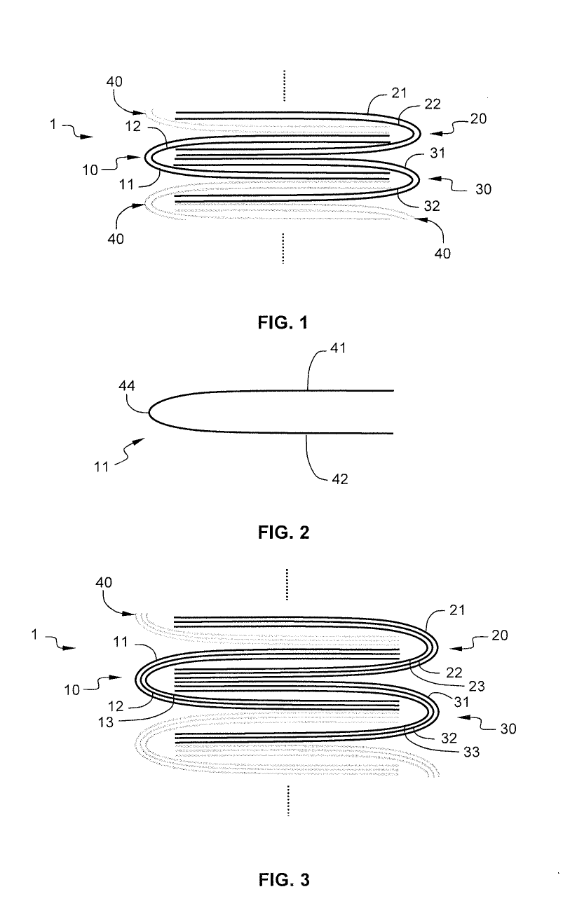

FIGS. 1 and 3 schematically illustrate side cross-section views of exemplary embodiments of stacks of interfolded absorbent sheet products.

FIG. 1 is a side cross-section view in a stack of interfolded absorbent sheet products 1 schematically illustrating a first embodiment. For sake of simplicity, FIG. 1 represents a stack including first, second and third groups of sheet products 10, 20, 30 respectively, and partially other adjacent group of sheet products 40. In this first embodiment, each group of sheet products 10, 20, 30 includes two sheet products 11 and 12, 21 and 22, 31 and 32, respectively, the sheet products of a given pair being superposed one above the other.

FIG. 2 depicts, in detail, a sheet product of a given pair, for example the one referenced 11, all the other sheet product 12, 21, 22, 31, 32 being identical or similar. The sheet product 11 is folded according to a V-Fold type of folding. A V-Fold is a type of folding wherein one fold creates two panels. In the present case, the sheet product 11 includes a first panel 41 coupled to a second panel 42 through a folding line 44. The first, second, third and adjacent group of sheet products 10, 20, 30, 40 are folded according to such a V-Fold type of folding.

The first group of sheet products 10 is orientated side by side in opposition relative to the second and third groups of sheet products 20, 30. The first group 10 is positioned with respect to the second and third groups 20, 30 such that the respective folding lines 44 are positioned opposite or spaced apart from each other. The first, second and third groups 10, 20, 30 are interfolded into each other so that the panels 41 (or 42) of two groups positioned adjacent relatively to each other 10 and 20 (or 10 and 30) overlap. In other word, a panel 41 of one group is nested between two panels 41 and 42 of an adjacent group.

FIG. 3 is a side cross-section view in a stack of interfolded absorbent sheet products 1 schematically illustrating a second embodiment. The second embodiment differs from the first embodiment in that each group of sheet products 10, 20, 30 includes three sheet products 11, 12 and 13, 21, 22 and 23, 31, 32 and 33, respectively, the sheet products of a given tierce being superposed one above the other.

The hereinbefore presented embodiments may be used for folding and stacking napkins that can be used in e.g. quick service restaurant. A group of napkins encloses a certain amount of napkins. Several groups of napkins are interfolded into each other forming a stack that may fill-in a container of a dispenser. Advantageously, the groups of napkins are oriented in the dispenser so that when a user grasps a group of napkins, all the napkins of a group are seized at the same time. Thus, the user may obtain several napkins in one grasping movement.

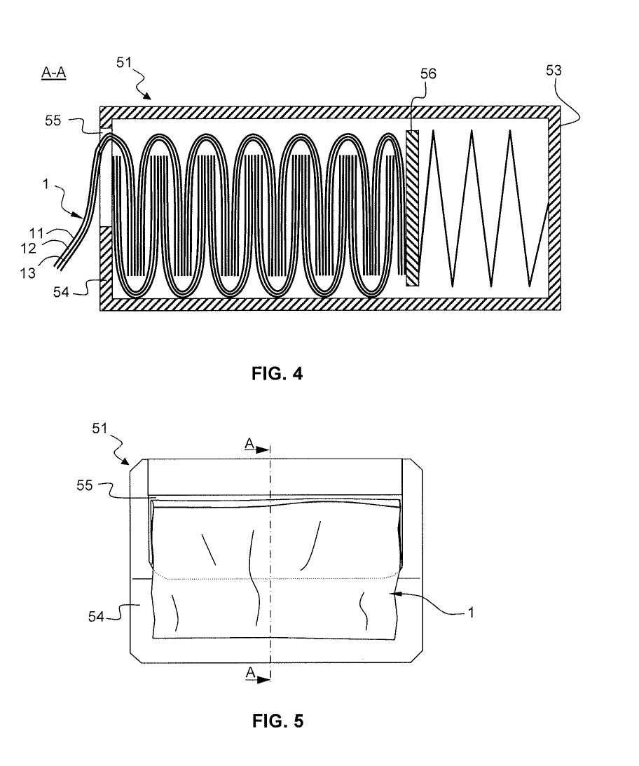

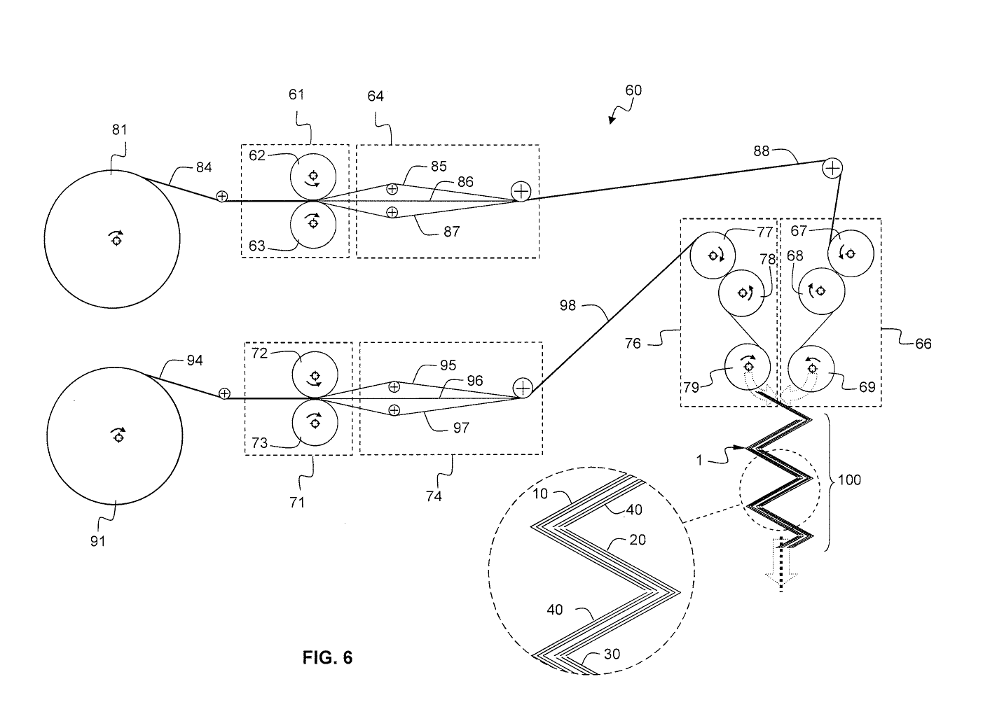

FIGS. 4 and 5 schematically illustrate an exemplary embodiment of a dispenser for dispensing such a stack of interfolded absorbent sheet products, e.g. napkins.

FIG. 5 is a front view schematically illustrating a horizontal dispenser 51. FIG. 4 is a lateral cross-section view according to the line A-A of the front view also schematically illustrating a horizontal dispenser 51. The dispenser 51 includes a container 53 of substantially parallelepiped shape orientated horizontally, a front face 54 provided with an opening 55, and a mechanism 56 for pushing napkins towards the front face 54. The container is filled in with a stack of interfolded absorbent sheet products, for example a stack of interfolded napkins positioned vertically. A user grasps a stack of interfolded napkins 1 through the opening 55. In one grasping movement, the user grasps the gaping panels of the group of napkins 11, 12 and 13. This results in the panels of the adjacent group of napkins gaping in the opposite direction from the opening 55, ready for a subsequent use.

Though FIG. 5 schematically illustrates a horizontal dispenser, this dispenser may also be disposed in a vertical configuration (not shown). A vertical dispenser may be integrated into, e.g. positioned under a table so as to dispense the napkins (or other products like toilet papers) through an appropriate hole of the table. As another alternative, a stack of interfolded absorbent sheet products, e.g. napkins may also be dispensed by a known stand or in-counter type dispenser or a wall dispenser.

FIGS. 6 to 9 schematically and partially illustrate four exemplary embodiments of a method and machine for manufacturing stacks of interfolded absorbent sheet products.

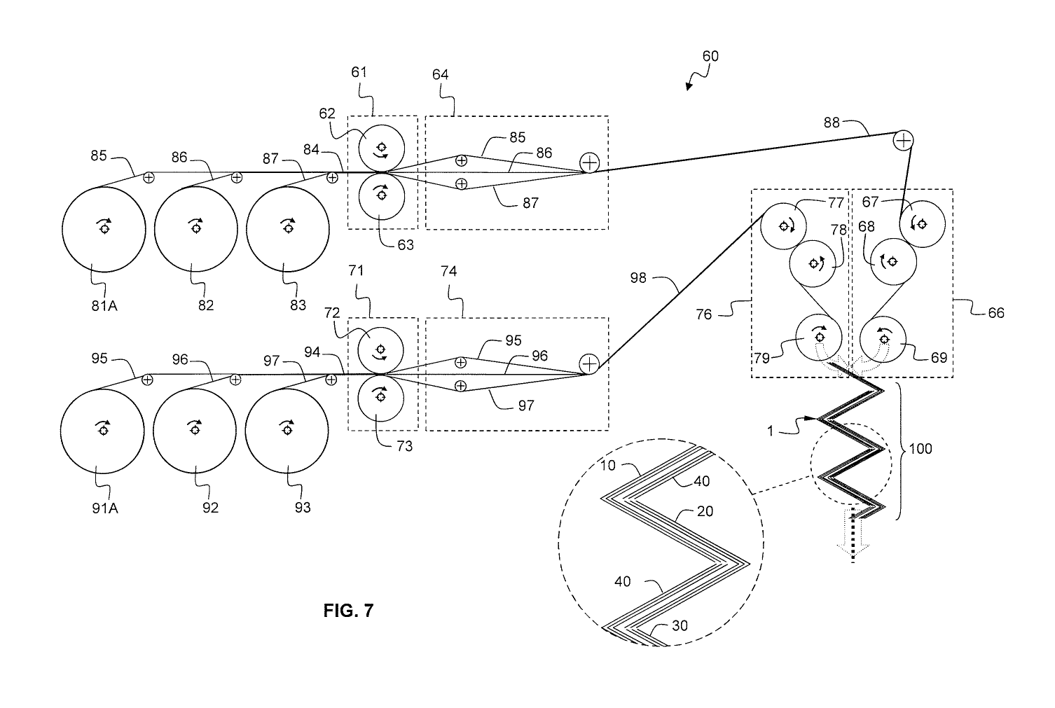

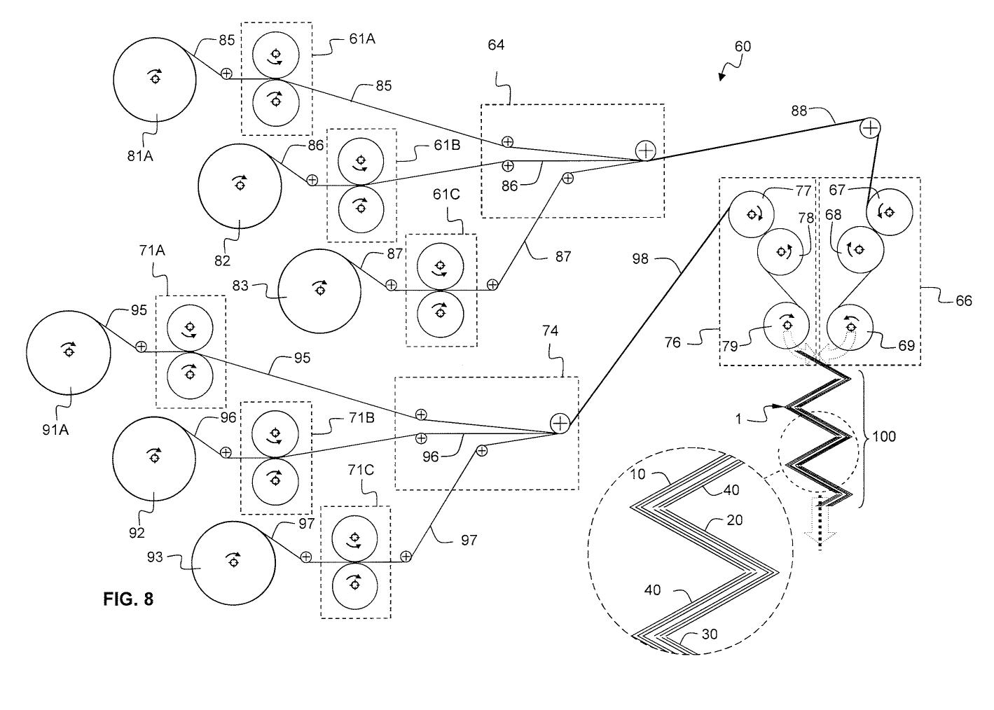

The manufacturing method includes the steps of interfolding a group of sheets issued from a certain amount of, for example three, tissue webs into adjacent groups of sheets also issued from a certain amount of, for example three, tissue webs. This is obtained either by uncoupling, cutting and folding sheets from a tissue web formed out of several plies issued from a single supply roll (FIG. 6), or by cutting and folding sheets issued from a certain amount of independent supply rolls (FIGS. 7 and 8).

The manufacturing machine 60 enables forming identical folds in a first group of sheets 10 and identical folds in a second group of sheets 20, each being issued from a certain amount, for example three different tissue webs, and assembling by interfolding said first group of sheets 10 into said second group of sheets 20 in a continuously moving stack 100.

According to a first embodiment depicted in FIG. 6, the manufacturing machine 60 includes a first and second supply roll 81, 91, a first and second structuring unit 61, 71, a first and second decoupling/combining unit 64, 74, and a first and second folding unit 66, 76.

First and second groups of tissue webs 84, 94 are led simultaneously to the first and second structuring unit 61, 71 from the supply rolls 81, 91, respectively. In this embodiment, each supply rolls 81, 91 supplies groups of tissue webs 84, 94 including three plies, namely three independent layers 85, 86, 87, and 95, 96, 97, respectively.

The first and second groups of tissue webs 84, 94 are unwound (in an unfolded condition) at an appropriate speed towards the first and second structuring unit 61, 71, respectively. All the plies of the first and second tissue webs 84, 94 are simultaneously structured in the structuring unit 61, 71, respectively. Each structuring unit 61, 71 includes a structuring roller 62, 72 and a counter structuring roller 63, 73, respectively. The motive that is structured in the first and second groups of tissue webs 84, 94 may be identical or different. Due to this operation, the plies forming the first group of tissue webs 84 may be nested in each other. This results in the first group of tissue webs 84 forms a single entity. The same is true regarding the second groups of tissue webs 94.

Then, the plies of the first and second groups of tissue webs 84, 94 are separated from each other by traveling them into the first and second decoupling/combining unit 64, 74, respectively. The first decoupling/combining unit 64 includes a plurality of rollers arranged to separate the plies forming the first group of tissue webs 84 from each other into three uncoupled tissue webs 85, 86 and 87, respectively. Then, the three uncoupled tissue webs 85, 86 and 87 are combined 88 (though not adhering together) in order to travel together towards the first folding unit 66. Similarly, the second decoupling/combining unit 74 includes a plurality of rollers arranged to separate the plies forming the second group of tissue webs 94 from each other into three uncoupled tissue webs 95, 96 and 97, respectively. Then, the three uncoupled tissue webs 95, 96 and 97 are combined 98 (though not adhering together) in order to travel together towards the second folding unit 76.

Each folding unit 66, 76 includes multiple rollers, e.g. a cutting roller 67, 77 respectively, a transporting roller 68, 78, respectively, and at least one folding roller 69, 79, respectively. Each roller of the first and folding second units 66, 76 is rotating at substantially the same speed. Each tissue web 85, 86, 87, and 95, 96, 97 is cut to an appropriate length by the cutting roller 67, 77 and then transported to the folding roller 69, 79, respectively. The first and second folding units 66, 76, in particular the first and second folding roller 69, 79 are positioned in a face to face configuration so as to enable interfolding of the first group of sheet products 10 with respect to the second group of sheet products 20. The first and second folding roller 69, 79 are located in spaced relationship with each other along the path of the stack 100 beneath them. Typically, the cutting roller 67, 77 may include a knife and the transporting roller 68, 78 may include a knife hammer (not shown). Typically, the folding roller 69, 79 may be of the air suction folding type that includes suction outlets and blowing outlets in order to maintain and fold panels in the cut sections of the combined tissue webs 88, 98. Alternatively, the folding roller 69, 79 may be of the mechanical folding type that includes folding fingers in order to maintain and fold panels in the cut sections of the combined tissue webs 88, 98. As a further alternative, the folding roller 69, 79 may be a combination of the air suction folding type and mechanical folding type.

FIG. 6 depicts an example wherein a stack of interfolded absorbent sheet products 1 is produced. In the frame of this embodiment, the first folding roller 69 forms a longitudinal median fold 44 in the first sheets cut from the combined tissue webs 88, such that the cross-section of the cut sheets forms a “V” having two panels as explained hereinbefore with respect to FIGS. 1-3. A first group of sheet products 10 is produced. The second folding roller 79 forms a longitudinal median fold 44 in the second sheets cut from the combined tissue webs 98, such that the cross-section of the cut sheets also forms a “V” having two panels. A second group of sheet products 20 is produced. The second group of sheet products 20 is positioned adjacently with respect to the first group of sheet products 10 such that the respective folding lines 44 are positioned opposite from each other. Further, a third group of sheet products 10 is produced by the first folding unit 66. The panels 41 and 42 of the first group of sheet products 10 are applied onto the panels 42 of the second group of sheet products 20 and also onto the panels 41 of the third group of sheet products 30. Thus, the first, second and third groups 10, 20, 30 are imbricated into each other. The above steps repeat continuously so as to imbricate the adjacent groups of sheet products. Therefore, a stack 100 of interfolded absorbent sheet products 1 is formed. A certain amount of such interfolded absorbent sheet products 1 may then be packaged in wrappers or boxes (not shown).

According to a second embodiment depicted in FIG. 7, the manufacturing machine 60 differs from the first embodiment in that the first supply roll 81 supplying a group of tissue webs 84 including three plies, namely three independent layers 85, 86, 87 has been replaced by three independent supply roll 81A, 82 and 83, each supply roll supplying a single tissue web (i.e. a unique ply) 85, 86 and 87, respectively. Similarly, the second supply roll 91 supplying a group of tissue webs 94 including three plies, namely three independent layers 95, 96, 97 has been replaced by three independent supply roll 91A, 92 and 93, each supply roll supplying a single tissue web (i.e. a unique ply) 95, 96 and 97, respectively. Both series of single tissue web 85, 86, 87 and 95, 96, 97 are then grouped into groups of tissue webs 84 and 94 before being led to the respective first and second structuring unit 61 and 71, respectively. The subsequent element of the manufacturing machine 60 and steps involved in the structuring, decoupling, cutting and folding are identical to those described in relation with FIG. 6. In particular, once again, the nesting effect inducing a certain linking between the single tissue webs 85, 86, 87 and 95, 96, 97 due to the structuring steps in the respective structuring units 61, 71 is corrected by the respective decoupling/combining unit 64, 74.

According to a third embodiment depicted in FIG. 8, the manufacturing machine 60 differs from the second embodiment in that each single tissue web (i.e. a unique ply) 85, 86, 87 and 95, 96, 97 is structured individually and separately in respective structuring unit 61A, 61B, 61C and 71A, 71B, 71C, respectively. Further, each decoupling/combining unit 64 and 74 includes a plurality of rollers arranged to combine (though not adhering together) the three independent tissue webs 85, 86, 87 and 95, 96, 97 into the combined tissue webs 88 and 98, respectively. Then, the combined tissue web 88 and 98 travels towards the first 66 and second 76 folding unit, respectively.

FIGS. 6, 7 and 8 depict that the rollers 67, 68, 69 associated with the first folding unit 66 as identical and symmetrical with respect to the rollers 77, 78, 79 associated with the second folding unit 76. Alternatively, the rollers may be different, for example the dimensions of the rollers of one folding unit may be different from the other in order to adapt different size of tissue webs or cut tissue webs and interfolds absorbent sheet products of different sizes (in the case where the dimensions of the first absorbent sheet product is different to the ones of the second absorbent sheet products).

In FIGS. 6 and 7, the structuring method may be understood as comprising various structuring method, like marking, ply bonding, embossing, steel to steel, steel to paper, steel to rubber, knurling, etc. . . . that enables providing a pattern or a structure to the tissue web.

In FIG. 8, the structuring method may be understood as including various structuring method, like steel to steel, steel to paper, steel to rubber, knurling, glue embossing, hot-melt bonding, ultrasonic bonding, etc. . . .

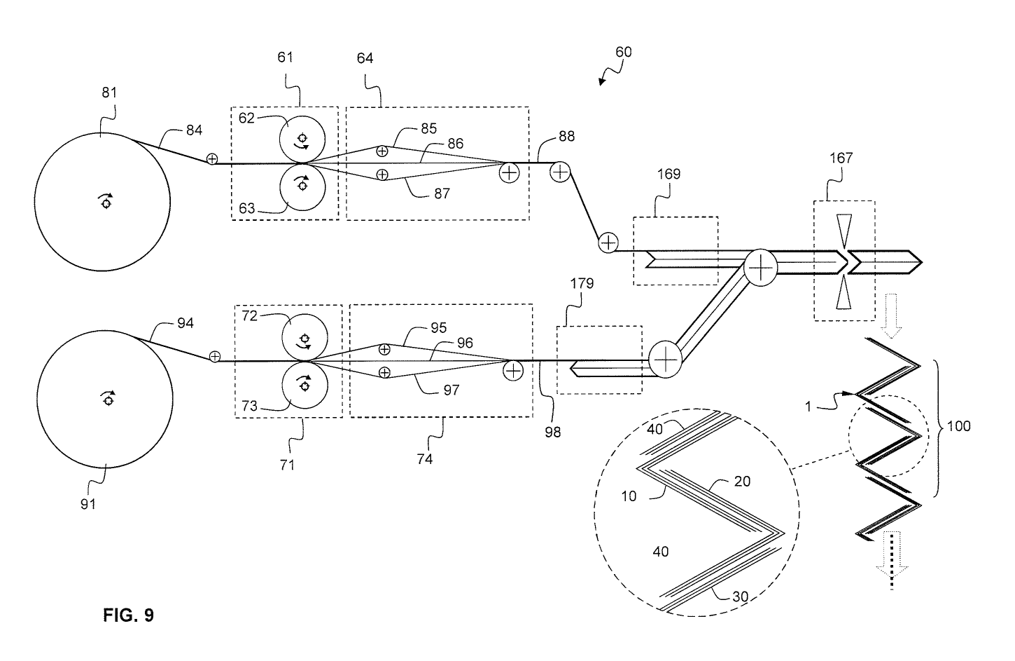

According to a fourth embodiment depicted in FIG. 9, the manufacturing machine 60 differs from the first embodiment in that the first and second folding unit 66, 76 are replaced by a first and second folding unit of another type 169, 179 and a single cutting unit 167. In particular, the combined tissue web 88 and 98 are first folded then cut. Moreover, each of the first and second folding unit 169, 179 is a plate folder, namely a folding unit of the type including a fold plate. Though, not shown, the folding units and single cutting unit of the fourth embodiment may be adapted to the second and third embodiment wherein three independent supply rolls are used, and wherein either the structuring step occurs for groups of plies or separately for the individual plies.

The choice of an embodiment is dependent on the final product to be achieved. With all the embodiments, it is possible to produce a stack of interfolded absorbent sheet products, wherein the characteristics (e.g. nature, color, feature purpose) of the first group of absorbent sheet products 10 relative to the second group of absorbent sheet product 20 are the same or different. This is done by selecting the characteristics of the first and second supply roll 81, 91. As an example, the stack may mix absorbent sheet products of different nature: first group of absorbent sheet products 10 comprises CWP products, while the second group of absorbent sheet products 20 comprises TAD products. With the second and third embodiment, it is even possible to produce a stack of interfolded absorbent sheet products, wherein the characteristics (e.g. nature, color, feature, purpose, etc . . . ) of each uncoupled absorbent sheet products 11, 12, 13, 21, 22, 23 in a group are the same or different. This is done by selecting the characteristics of the individual supply rolls 81A, 82, 83, 91A, 92, 93. As a first example, the stack may mix absorbent sheet products of different colors: each group of sheet products 10, 20, 30 may include a first sheet product of color yellow 11, 21, 31, a second sheet product of color red 12, 22, 32 and a third sheet product of color cream 13, 23, 33. As a second example, the stack may mix absorbent sheet products of different purpose: each group of sheet products 10, 20, 30 may include a first sheet product of very absorbent product 11, 21, 31, a second sheet product of low absorbency but resistant product 12, 22, 32 and a third sheet product of low absorbency in a contrasting color 13, 23, 33.

The drawings and their descriptions hereinbefore illustrate rather than limit the invention.

Though the invention has been described with respect to various embodiments of interfolded absorbent sheet products wherein one group of absorbent sheet products (first 10, second 20, third 30 or other adjacent 40 groups of absorbent sheet products) comprises two or three uncoupled absorbent sheet products, these are not limitative examples. The skilled person will readily recognize that each group of absorbent sheet products may comprise more independent and separated absorbent sheet products in a group (i.e. the certain amount), e.g. four, five, six, etc . . . provided that sufficient plies in a single supply roll or independent supply rolls are used during the manufacturing process.

The particular application of the product as napkins in the frame of quick service restaurant application is only an example as numerous other sanitary or domestic applications are also possible (e.g. towels, kitchen towels, hand towels, toilet papers, wipes, facial tissues, bath tissues etc . . . ).

Also the V-fold type of folding in the depicted embodiments is a non limitative example. The skilled person will readily recognize that this type of folding may be changed if desired or deemed necessary with respect to, for example, the uniformity of dispensing, the practicality or even the desired aesthetic effect to be achieved.

Any reference sign in a claim should not be construed as limiting the claim. The word “comprising” does not exclude the presence of other elements than those listed in a claim. The word “a” or “an” or “at least one” preceding an element does not exclude the presence of a plurality of such element.

1. A stack of interfolded absorbent sheet products comprising:
a plurality of a first group of absorbent sheet products folded according to a first type of folding wherein at least two panels are created by at least one folding line; and
a plurality of a second group of absorbent sheet products folded according to a second type of folding wherein at least two other panels are created by at least one other folding line,
wherein the plurality of the first and second groups are orientated side by side in opposition relative to each other, the plurality of the first and second groups being interfolded into each other so that the panels of two groups positioned adjacent relative to each other overlap, and
wherein each group of absorbent sheet products comprises a certain amount, at least two, of uncoupled absorbent sheet products so as to dispense the certain amount of absorbent sheet products with one grasping movement of the group.

2. The stack of folded absorbent sheet products of claim 1, wherein the first type of folding is identical to the second type of folding.

3. The stack of interfolded absorbent sheet products of claim 1, wherein the certain amount ranges between two and six.

4. The stack of interfolded absorbent sheet products according to claim 1, wherein sizes of the first group of absorbent sheet products relative to the second group of absorbent sheet products are identical.

5. The stack of interfolded absorbent sheet products according to claim 1, wherein the type of folding is chosen from among the group consisting of V-fold, wherein two panels are created by one fold; Z-fold, wherein three panels are created by two folds made in opposite directions; and M-fold, wherein four panels are created by three folds.

6. The stack of interfolded absorbent sheet products according to claim 1, wherein characteristics of the first group of absorbent sheet products relative to the second group of absorbent sheet products are different.

7. The stack of interfolded absorbent sheet products according to claim 1, wherein characteristics of each of uncoupled absorbent sheet products in a group are different from each other.

8. The stack of interfolded absorbent sheet products according to claim 1, wherein the absorbent sheet products are chosen from among the group consisting of napkins, towels, kitchen towels, hand towels, toilet papers, wipes and facial tissues.

9. A dispenser comprising the stack of interfolded absorbent sheet products according to claim 1, wherein the dispenser comprises a container wherein the stack of interfolded absorbent sheet products is disposed, and wherein the stack of interfolded absorbent sheet products is oriented in the dispenser so that when a user grasps one group of absorbent sheet products a certain amount of absorbent sheet products is seized at the same time.

10. The dispenser of claim 9, wherein a front face of the dispenser comprises an opening allowing the group of absorbent sheet products to gape of the container and through which the stack of interfolded absorbent sheet products is seized.

11. A method for manufacturing a stack of interfolded absorbent sheet products, comprising:
folding a plurality of a first group of absorbent sheet products according to a first type of folding wherein at least two panels are created by at least one folding line;
folding a plurality of a second group of absorbent sheet products according to a second type of folding wherein at least two other panels are created by at least one other folding line;
orientating the plurality of the first and second groups side by side in opposition relative to each other, and interfolding the plurality of the first and second groups into each other so that the panels of two groups positioned adjacent relative to each other overlap; and
supplying each group of absorbent sheet products with a certain amount, at least two, of uncoupled absorbent sheet products.

12. The manufacturing method of claim 11, wherein supplying the certain amount of uncoupled absorbent sheet products comprises providing a tissue web formed out of several plies from a single supply roll, separating the tissue web formed out of several plies into the certain amount of uncoupled tissue webs. combining the certain amount of uncoupled tissue webs into combined tissue webs, and cutting the certain amount of uncoupled tissue webs of the combined tissue webs in a simultaneous manner.

13. The manufacturing method of claim 12, wherein supplying the certain amount of uncoupled absorbent sheet products further comprises structuring the tissue web formed out of several plies before the uncoupling step.

14. The manufacturing method of claim 11, wherein supplying the certain amount of uncoupled absorbent sheet products comprises providing uncoupled tissue webs from a certain amount of supply rolls, combining the certain amount of uncoupled tissue webs into combined tissue webs, and cutting the certain amount of uncoupled tissue webs of the combined tissue webs in a simultaneous manner.

15. The manufacturing method of claim 14, wherein supplying the certain amount of uncoupled absorbent sheet products further comprises structuring the tissue web formed out of several plies before the cutting step.

16. The manufacturing method of claim 11, wherein supplying the certain amount of uncoupled absorbent sheet products comprises providing multiple tissue webs from a certain amount of supply rolls, each roll providing a single tissue web, structuring the multiple tissue webs together, uncoupling the structured tissue webs into the certain amount of uncoupled tissue webs, combining the certain amount of uncoupled tissue webs into combined tissue webs, and cutting the certain amount of uncoupled tissue webs of the combined tissue webs in a simultaneous manner.

17. The manufacturing method according to claim 11, wherein the certain amount ranges between two and six.

18. A dispenser comprising the stack of interfolded absorbent sheet products according to claim 1 as napkins.

19. The stack of folded absorbent sheet products of claim 1, wherein the first type of folding is different from the second type of folding.
